(19) United States
(12) Patent Application Publication
(10) Pub. No.: US 2024/0212417 A1
(43) Pub. Date: Jun. 27, 2024

(54) GEOGRAPHICAL DRAW-STYLE WAGERING

(71) Applicant: IGT, Las Vegas, NV (US)

(72) Inventors: Dwayne NELSON, Las Vegas, NV (US); Patrick DANIELSON, Las Vegas, NV (US)

(21) Appl. No.: 18/086,371

(22) Filed: Dec. 21, 2022

(51) Int. Cl. G07F 17/32

(52) U.S. Cl. CPC G07F 17/3209; G07F 17/3211; G07F 17/326

(57) ABSTRACT

Systems devices and methods of draw-style wagering games are provided. Methods may include receiving a wager for a geographic map based gridless keno-style wagering game at a gaming device, receiving multiple map selections for the geographic map based gridless keno-style wagering game at the gaming device and causing a display device of the gaming device to display a graphical user interface (GUI). The GUI may include a geographic map including multiple map features, multiple geographical selections on the geographic map and multiple drawn geographical image zones corresponding to portions of the geographic map that are determined from a draw. For each drawn geographical image zone that corresponds to of the plurality of geographical selections, methods may include determining that the drawn geographical image zone is a hit and displaying a hit indicator at the geographical selections corresponding to the drawn geographical image zone.

### BACKGROUND

Embodiments described herein relate to game play features with electronic wagering games, and in particular, to a draw-style wagering game for use in a gaming environment, such as in a casino environment, and related devices, systems, and methods. Examples of draw style wagering games include keno and lottery types of games. Players of different types of wagering games may be resistant to playing other types of wagering games for a number of reasons, including familiarity, loyalty, habit, and other reasons. For example, a player who primarily plays draw-style wagering games may be resistant to playing slot games, and vice versa. There is a need for different types of games to attract a wider variety of players of different wagering games.

### BRIEF SUMMARY

According to some embodiments, a system includes a processor circuit and a memory including machine-readable instructions. When executed by the processor circuit, the instructions cause the processor circuit to receive an indication of a wager for a draw-style wagering game by a player at a gaming device. The instructions further cause the processor circuit to receive an indication of a wager for a draw-style wagering game by a player using a gaming device, receive an indication of multiple geographical selections on a geographical image for the draw-style wagering game using the gaming device, and cause a display device of the gaming device to display a graphical user interface (GUI). The GUI includes the geographical image including multiple geographical image zones and the geographical selections on the geographical image. The processor circuit further causes the display device to display multiple drawn geographical image zones corresponding to the geographical image. For each drawn geographical image, the processor circuit is further caused to determine whether the drawn geographical image zone corresponds to any of the geographical selections on the geographical image. For each drawn geographical image zone that corresponds to of the geographical selections, the processor circuit is caused to determine that the drawn geographical image zone is a hit and display a hit indicator at the geographical selections corresponding to the drawn geographical image zone. Based on a number of hits, the processor circuit is further caused to generate a game result for the draw-style wagering game. In response to the game result being a winning game result, the processor circuit is further caused to provide an award to a player of the draw-style wagering game.

According to some embodiments, a gaming device includes a display device, an input device, a processor circuit, and a memory including machine-readable instructions. When executed by the processor circuit, the instructions cause the processor circuit to receive, via the input device, an indication of a wager for a draw-style wagering game by a player using a gaming device, receive, via the input device, an indication of multiple geographical selections on a geographical image for the draw-style wagering game using the gaming device, and cause the display device of the gaming device to display a graphical user interface (GUI). In some embodiments, the GUI includes the geographical image including multiple geographical image zones, the geographical selections on the geographical image, and cause the display device to display multiple drawn geographical image zones corresponding to the geographical image. Some embodiments provide that, for each drawn geographical image, the processor circuit is caused to determine whether the drawn geographical image zone corresponds to any of the geographical selections on a geographical image. In some embodiments, for each drawn geographical image zone that corresponds to one of the geographical selections, the processor circuit is caused to determine that the drawn geographical image zone is a hit and to display a hit indicator at the one of the geographical selections corresponding to the drawn geographical image zone. The processor circuit is further caused to generate a game result for the draw-style wagering game and, in response to the game result being a winning game result, provide an award to a player of the draw-style wagering game.

According to some embodiments, a method includes operations including receiving a wager for a geographic map based gridless keno-style wagering game at a gaming device and receiving multiple map selections for the geographic map based gridless keno-style wagering game at the gaming device. Operations further include causing a display device of the gaming device to display a graphical user interface (GUI). The GUI includes a geographic map including multiple map features, multiple geographical selections on the geographic map, and multiple drawn geographical image zones corresponding to portions of the geographic map that are determined from a draw. Operations further include, for each drawn geographical image zone that corresponds to of the plurality of geographical selections, determining that the drawn geographical image zone is a hit and displaying a hit indicator at the one of the geographical selections corresponding to the drawn geographical image zone.

### BRIEF DESCRIPTION OF SEVERAL VIEWS OF THE DRAWINGS

FIG. 1 is a partial schematic geographical map of an area in accordance with some embodiments herein.

FIG. 2 is a schematic illustration of a sample paytable that may be similar to a keno-style paytable according to some embodiments.

FIG. 3 is a schematic block diagram illustrating example player selected geographic areas and drawn geographic areas in accordance with some embodiments herein.

FIG. 4 is a schematic block diagram that illustrates the selected and drawn geographical areas of FIG. 3 with the addition of the map as the playfield according to some embodiments.

FIG. 5 is a schematic diagram illustrating a geographical area in which many players have placed pins according to some embodiments.

FIG. 6 is a schematic diagram illustrating evaluation of one or more selected geographical areas according to some embodiments herein.

FIG. 7 is a schematic block diagram illustrating a network configuration for a plurality of gaming devices according to some embodiments.

FIG. 8A is a schematic block diagram illustrating an electronic configuration for a gaming device according to some embodiments.

FIG. 8B is a schematic block diagram that illustrates various functional modules of a gaming device according to some embodiments.

FIG. 8C is perspective view of a gaming device that can be configured according to some embodiments.

FIG. 9 is a flowchart illustrating operations of systems/methods of facilitating participation in a wagering game between multiple devices, according to some embodiments.

FIG. 10 is a flowchart illustrating operations of systems/methods of facilitating participation in a wagering game between multiple devices, according to some embodiments.

### DETAILED DESCRIPTION

Embodiments described herein relate to game play features with electronic wagering games, and in particular, to draw style wagering games such as keno and/or lottery wagering games. Some embodiments provide a draw style wagering game in which a player may choose geographical locations on a map or globe instead of choosing numbers from a range and/or from a keno card. In some embodiments, the user is presented with a map and/or globe via a display device that displays a graphical user interface (GUI). In some embodiments, the user may pay to place a pin marker on the map/globe. The draw style wagering game may, using a random drawing process, pick a location on the map/globe and the person with the pin that is the closest to the drawn geographical location wins. In some embodiments, a winner may be chosen by some distance, area and/or radius around the chosen pin, such as 10 meters. Some embodiments herein may provide the inclusion of advertising and/or charitable giving components.

Previously some systems have converted maps into grids of multiple rectangular shapes thus making the map a simple analogy for lottery numbers. In contrast, embodiments herein allow the player to pick any place without restrictions. Further, the player may alter the shape and/or size of the selected area. In some embodiments, the selected geographical area may be further defined to include three-dimensional (3D) areas. In some embodiments, players may select multiple locations, which may be similar to a 5 number lottery system and/or a keno card with 20 numbers picked randomly by the system. Such advantages may be significant. Some embodiments provide that the geographical area may be irregular shapes and not merely square keno cards with square keno numbers aligned in a perfect grid. In such embodiments, the geographical area may be gridless.

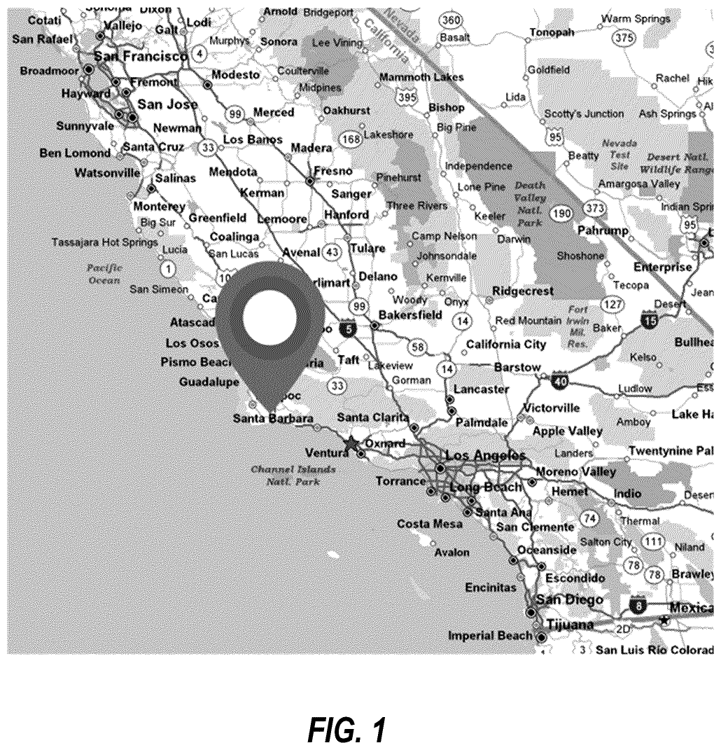

The present disclosure involves a keno or lottery system that allows the user to choose locations on a map or globe instead of choosing numbers. In the simplest embodiment the user is presented a map or globe instead of a regular keno card or range or numbers. The user pays to place a pin marker on the globe. The draw picks a location on the map or globe and the person with the closest pin wins. In one embodiment the winner is chosen by some distance, area or radius around the chosen pin, such as 10 meters. Brief reference is made to FIG. 1, which is a partial schematic geographical map of an area in accordance with some embodiments herein. As illustrated, the player may place a pin that identifies a selected geographical position of the geographical map. For example, pin is located near Santa Barbara.

In some embodiments, the player of the game might choose a special place such as their birthplace, hometown, desired vacation destination, desired retirement location, a property they wish to purchase, the location of a loved one, the location where they met someone special and/or the location of a favorite sports team, among others.

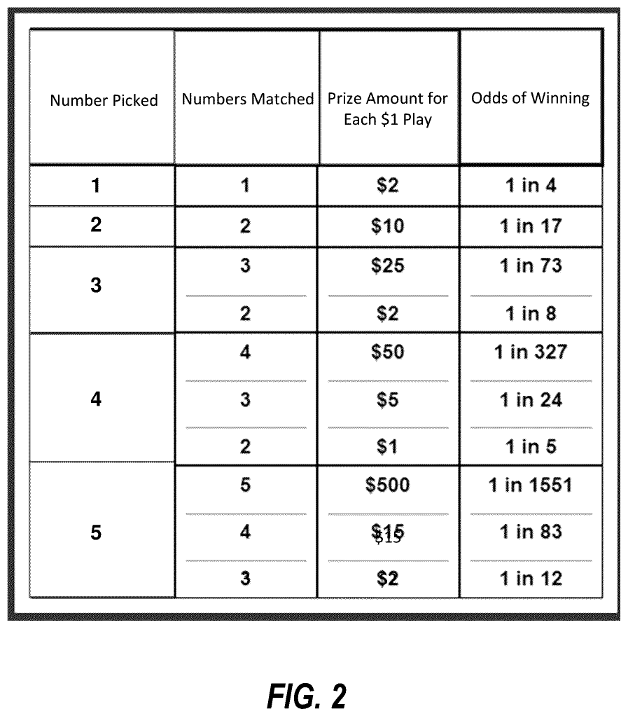

While only showing a single pin, embodiments herein provide that a player my pick multiple pin locations. In some embodiments, the example image shows a map and one pin, but multiple keno draws may be pinned onto the geographical map. In some embodiments, the value of the pins may be determined by a paytable. For example, brief reference is now made to FIG. 2, which is a schematic illustration of a sample paytable that may be similar to a keno-style paytable according to some embodiments. Some embodiments may leverage other Keno concepts, such as the player picking spots and/or allowing the system to randomly choose them for the player (sometimes called the “Quick Pick” feature). Some embodiments can be played at a video Keno terminal, mobile application and/or website. Some embodiments may be implemented as a traditional keno game with an overhead sign displaying the random locations and the players viewing their “Keno Cards” on player mobile devices. In this manner, the present disclosure is distinct from a traditional Keno system.

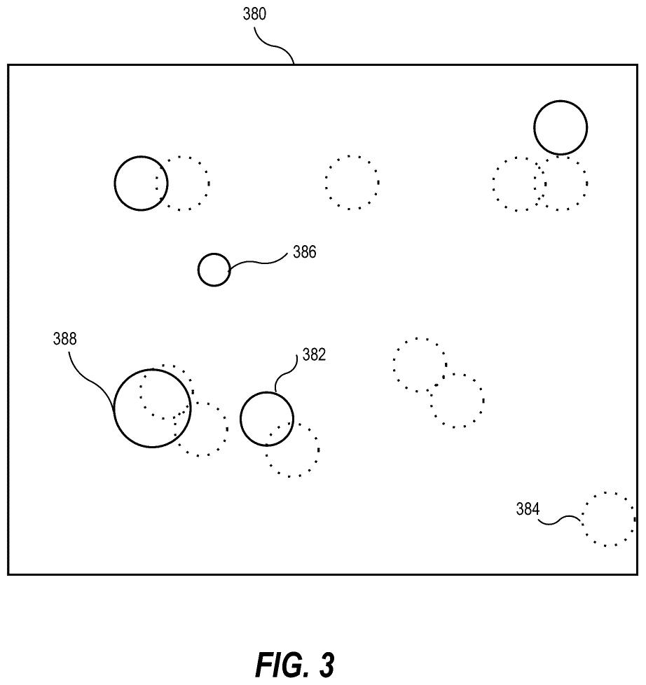

Brief reference is now made to FIG. 3, which is a schematic block diagram illustrating example player selected geographic areas and drawn geographic areas in accordance with some embodiments herein. As illustrate in FIG. 3, the playfield is a rectangle with the map/image removed to demonstrate aspects disclosed herein. In some embodiments, the playfield 380 may be any shape that is different from a rectangle. In the current embodiments, the player may make 5 picks, shown as solid line circles 382. The system may randomly choose the dashed line circles 384. In some embodiments, the randomly chosen dashed line circles 384 can overlap with other randomly chosen dashed line circles, while in some embodiments the randomly chosen circles may not be able to intersect with one another. In this example, the player has matched 3 and would be paid if there is a payback for matching 3.

In some embodiments, the selected geographical areas may be the same size, whereas some other embodiments provide that the selected geographical areas may be different sizes. For example, the selected geographical area of circles 382, 388, and 386 are all different sizes from one another. In other embodiments the selected geographical areas may be of different shapes.

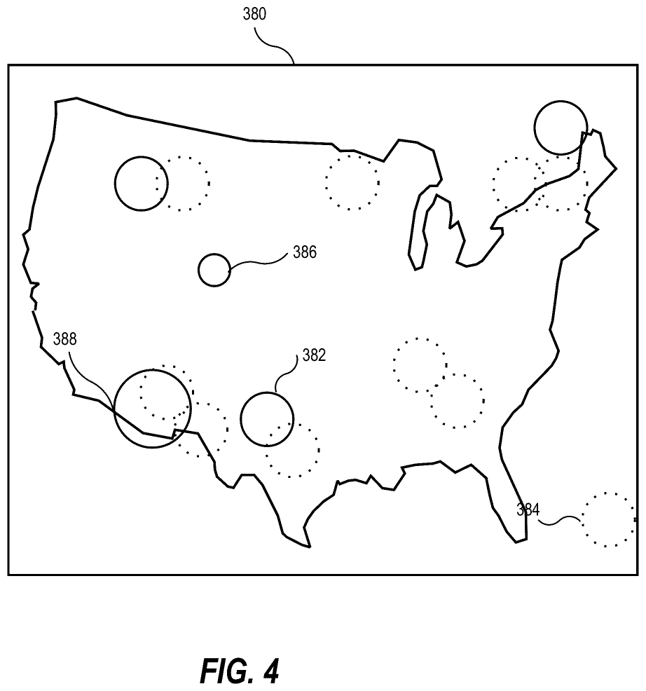

Error! Reference source not found. shows the disclosure without a map image and in fact, in some embodiments of the present disclosure do not utilize a map. In some embodiments, the playfield may be a shape of a certain color and/or image. However, the geographical area may include a map. For example, brief reference is now made to FIG. 4, which is a schematic block diagram that illustrates the selected and drawn geographical areas of FIG. 3 with the addition of the map as the playfield according to some embodiments.

In some embodiments, the user can place the pin and specify a radius. The larger the radius, the more likely the player is to win. In some embodiments, the cost increases for the wager proportionally to the area covered. In some embodiments, the player can place a shape such as a square, diamond and/or heart and may scale the shape and/or may change the orientation of the shape. In some embodiments, the winning shape must intersect with the shape chosen during the lottery draw. In some embodiments, the player is allowed to upload and use a custom shape or icon. For example, the player could upload a logo from their favorite sports team and place it on the map. That icon could be the NFL Raiders logo and the player might place it on the Stadium for the location of the next SuperBowl.

In some embodiments, the pin location may have multiple meanings. For example, a first meaning is that the player is choosing a location (or multiple locations) they hope will be randomly chosen by the system. In addition to this evaluation or alternatively to this evaluation, the pin location could present another wager. For example, the player may place the pin on Raider Stadium in Las Vegas and 4 other locations. The game may be played in which the system chooses 20 random locations on the map. The player may be awarded, based on a payment schedule, for any player pins near the 20 random locations. The player may also win if the Raiders win the Super Bowl, win the next game and/or win some wager specifically related to the Raider Stadium.

In some embodiments, a player user interface may allow the player to search for certain markers such as a particular logo. This may allow people in social groups to see what other members of their group are doing and/or to possibly make a statement.

In one embodiment the player can create an area such as a free form shape such as an oval. The user interface would evaluate the amount of area created and display the amount of money the player would need to bet based on using that free form shaped area. Since the player can select areas or create pins of varying radius, some embodiments provide that the user interface may show the player the amount of area selected and/or the odds or approximate odds of winning. For example, in response to the player drawing an area with their finger, system may show that the player selected 23 square meters, which has the odds of 1 in 230 million and costs $7.

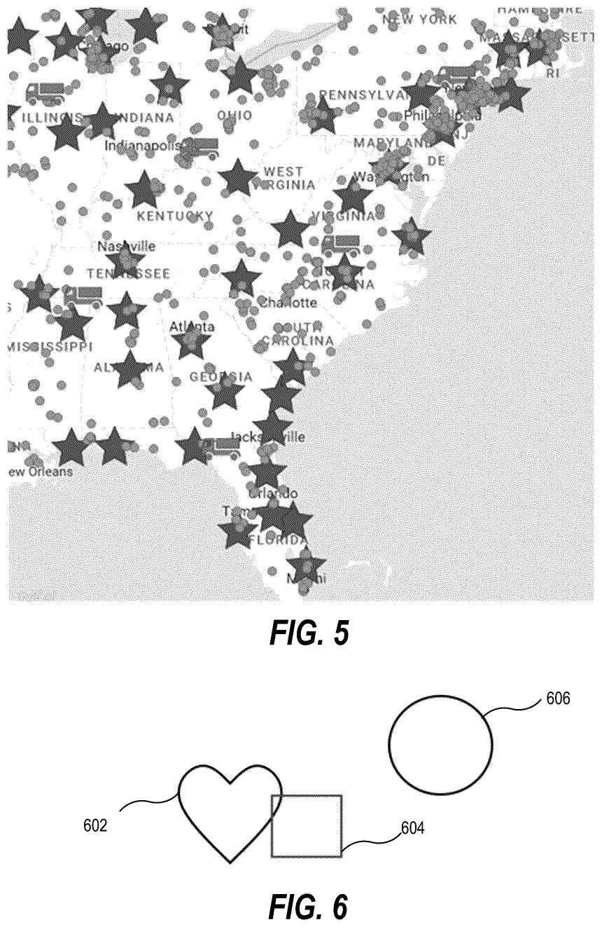

Reference is now made to FIG. 5, which is a schematic diagram illustrating a geographical area in which many players have placed pins according to some embodiments. As illustrated, each icon or symbol may represent a selected geographical area. In some embodiments, the player may only place pins in certain areas, such as on land and not on water. In some embodiments, a players marker cannot overlap another player's marker while other embodiments the markers may be overlapping with one another. In some embodiments, the markers must be separated by some distance.

In some embodiments, a player interface may allow the user to move around a map and zoom in and zoom out to find the location to pick. Some embodiments provide that the interface may allow the player to enter a zip code and/or other named location to zoom in.

In some embodiments, the player can see all of the pins or marked areas that other players have already placed on the map, while in some embodiments the player can only see his own pins. Seeing other players pins may add another dimension to the game and give the player an opportunity for a perceived strategy. For example, the player might see that everyone is picking Hawaii so if he won, the pool would be too small after being split so he picks another location.

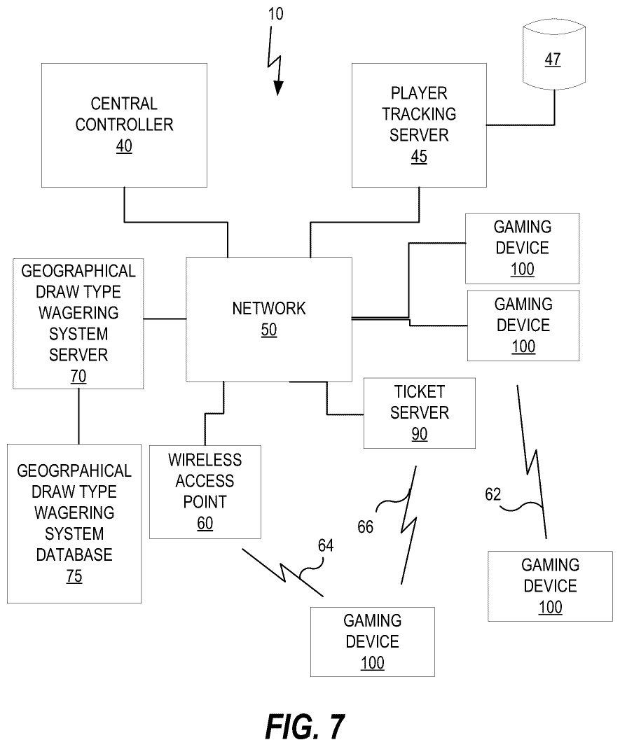

For the evaluation of the game, the system may first randomly pick a location on the map. In some embodiments, the system also uses and/or randomly picks a shape for the drawn geographical area. The system may then find a player pin/marker that intersects with the randomly selected drawn shape. For example, brief reference is now made to FIG. 6, which is a schematic diagram illustrating evaluation of one or more selected geographical areas according to some embodiments herein. A small section of a map where two players place their markers is illustrated. For example, one is a heart 602 and the other is a circle 606. The system randomly picks a location on the map and uses (or randomly selects) and square 604 area to evaluate. Since the square 604 intersects with the heart 602, the heart players is a winner. If there were no intersection there would be no winners. If multiple player markers were intersecting then all those intersecting would win and split the lottery pool. This example is only describing how one symbol (player choice location and icon) overlaps with another symbol (randomly chosen location and symbol) chosen by the host system. In a keno-style embodiment there may be more than one player choices, such as 5, and more than one system choices, such as 20.

In one some embodiments, the player with the marker/pin closest to the randomly chosen location wins.

In some embodiments, where there is an overlap of area in a lottery style game and using a lottery embodiment, the player can share the lottery award by allowing both players as equal winners. In some embodiments, the win could be scaled by geographical distance to the exact pin location. For example, if the heart player's exact location is 2 kilometers further away than the square player's, the award could be shared via a percentage in comparison to the other players marker (e.g., 43% and 57% respectively).

In some lottery style embodiments, players could be encouraged to pick the same location, such as a city or other landmark. This may allow players to pick places and things that have important meaning to them. If one was to be a winner, all of the players that picked it would essentially win, which may result in an inadvertent type of bet pooling based on preference.

In some embodiments, lottery games may pick road, train, boat, hiking, and/or air routes to create specific path patterns. For example, a fan hiker of the Appalachian trail may want to connect with their route to associate their lottery game through multiple points. Items such as distance, points of interest, and/or landmarks may be used to increase the odds and award levels.

In some embodiments, geocaching and trivia may be used through a lottery system for locality lotteries. A player may receive a set of clues to follow to unlock a geocache, which would either be a winning ticket, registration for a lottery game, and/or would allow a consolidation prize.

In some embodiments, tiered prizes may provide a tiered award prize that coincides with varying areas and/or differing radius from the chosen point. For example, the system may pick a random location. The primary prize of $100 million is awarded to any player who chose a location within 1 meter of the random location. A secondary prize of $2 million is awarded amongst players who chose location within 1000 meters of the randomly selected location. Any number of tiers could be created. Instead of differing by radius, each tier of the prize pool could vary by shape or surface area of a shape that isn't a circle.

A multi-draw may provide that the lottery draw is more than one random area. In some embodiments, the player may be allowed to pick more than one pin or marker. A player wins for each of his chosen pins (or markers) that are within one of the randomly chosen areas. For example, the player chooses 5 locations around the globe. The lottery system randomly choses 5 locations. Each location has a certain radius of evaluation. In this example the radius may be 10 kilometers. Any player with a pin within each of the 10-kilometer circles would be a winner.

In some embodiments, the draw may be one random location per continent. In some other embodiments the draw is one random location in 5 different countries and/or states of a single country. In this manner, the game may be able to be scaled. For example, the new game might start with smaller countries and move onto larger countries to increase the payback and decrease the odds of winning.

In some embodiments, the pins could be placed in 3 dimensions such that the player picks a location on the map and/or globe and also picks the altitude. Instead of an area, a volume (such as a sphere or cube) may be used. The system may pick one or more 3D objects and locations for evaluation. In some embodiments, the height may be capped by some value such as 30,000 feet. The lower bound may be the ground or ocean floor or it could be sea level.

In some embodiments the location can impact the award. For example, some embodiments provide that the map shows advertisers. The player may be encouraged to place a marker near or around the advertised location. In some embodiments, the advertiser adds to the award. For example, a theme park might advertise and show on the map. A lottery winner could win the lottery prize plus a lifetime membership to the theme park. In some embodiments, the advertiser may receive a portion of the prize if the winning location is near the advertiser location. The special location may include businesses, parks, states, regions, and/or any region on the map.

In some embodiments, a charity may optionally receive a portion of any win. The location of the placed pin or the style of the pin might impact the lottery. For example, a region, such as the Pacific Ocean, might be tied to GreenPeace. A winning marker in the ocean may give a portion of the win (such as 10%) to the GreenPeace charity. In some embodiments, the player places a particular pin to give to charity. For example, the player might place a “whale” pin/marker to give money to GreenPeace or use a regular pin to not give any money to the charity. The charity could be a national park, a school district and/or charity among others. For example, placing a marker in California might award a percentage of the win to the California school district to fund education.

In some embodiments, the geography could impact the prize, the radius of the pin and/or the odds. For example, pins near the water might be less likely to win than pins further from the water. In some embodiments, placing a pin along the water may have fixed radius such as a one radius while pins further from water have a larger radius. This mechanism may be used to encourage people to spread the pins across the map. Similarly, the altitude and/or proximity to mountains, geological features, forests, volcanoes, rivers, and/or deserts, among others may impact the payout.

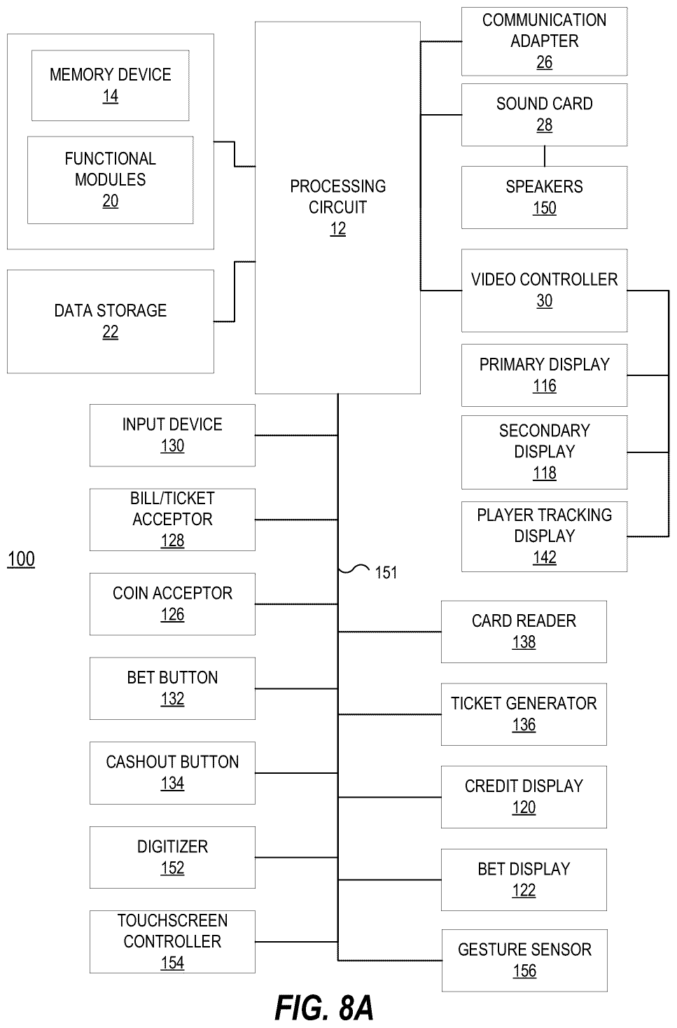

Referring now to FIG. 7, a gaming system 10 including a plurality of gaming devices 100 is illustrated. As discussed above, the gaming devices 100 may be one type of a variety of different types of gaming devices, such as electronic gaming machines (EGMs), mobile gaming devices, virtual lottery kiosks, keno terminals/and or kiosks and/or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 7, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

A geographical draw type wagering system server 70 may manage access, update, storage, evaluation, outcome determination, and/or multiplayer game status. The geographical draw type wagering system may be stored in a geographical draw type wagering system database 75. The geographical draw type wagering system server 70 and/or geographical draw type wagering system database 75 may be implemented within or separately from each other.

As further illustrated in FIG. 7, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

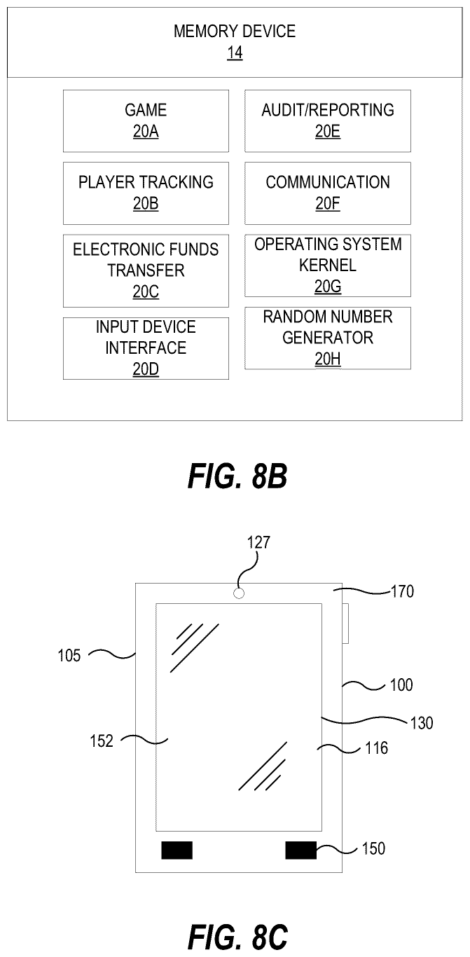

Embodiments herein may include different types of gaming devices. One example of a gaming device includes a gaming device 100 that can use gesture and/or touch-based inputs according to various embodiments is illustrated in FIGS. 8A-8C.

Reference is now made to FIG. 8A, which is a functional block diagram that schematically illustrates an electronic relationship of various elements of the gaming device, FIG. 8B, which illustrates various functional modules that can be stored in a memory device of the gaming device, and FIG. 8C, which is a perspective view of a gaming device that can be configured according to some embodiments.

The embodiments shown in FIGS. 8A-8C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of features, many of which are illustrated in FIGS. 8A and 8B. For example, referring to FIG. 8A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 8A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 8A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIG. 8A includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 8A, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 142. Accordingly, any of the above-described input devices, such as the input device 130, the game play initiation button 132 and/or the cashout button 134 may be provided as virtual buttons or regions on one or more of the display devices 116, 118, 142.

Still referring to FIG. 8A, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

The display devices 116, 118, 142 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 142 may include a touch-screen with an associated touchscreen controller 154 and digitizer 152. The display devices 116, 118, 142 may be of any suitable size, shape, and/or configuration. The display devices 116, 118, 142 may include flat or curved display surfaces.

The display devices 116, 118, 142 and video controller 30 of the gaming device 100 are generally configured to display one or more game and/or non-game images, symbols, and indicia. In certain embodiments, the display devices 116, 118, 142 of the gaming device 100 are configured to display any suitable visual representation or exhibition of the movement of objects; dynamic lighting; video images; images of people, characters, places, things, and faces of cards; and the like. In certain embodiments, the display devices 116, 118, 142 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 142 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

The gaming device 100 may also include a currency dispenser that may include a note dispenser configured to dispense paper currency and/or a coin generator configured to dispense coins or tokens in a coin payout tray.

The gaming device 100 may further include one or more speakers 150 controlled by one or more sound cards 28. The gaming device 100 illustrated in FIG. 8A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 142 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 8A is a block diagram that illustrates logical and functional relationships between various components of a gaming device 100. It should also be understood that components described in FIG. 8A may also be used in other computing devices, as desired, such as mobile computing devices for example. As shown in FIG. 8A, the gaming device 100 may include a processing circuit 12 that controls operations of the gaming device 100. Although illustrated as a single processing circuit, multiple special purpose and/or general purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 8A as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 8C.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 142 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 8B. Referring to FIG. 8B, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 8C, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, geographical draw type games, or other casino or non-casino style games. Further, gaming devices according to embodiments herein may be implemented using other computing devices and mobile devices, such as smart phones, tablets, and/or personal computers, among others.

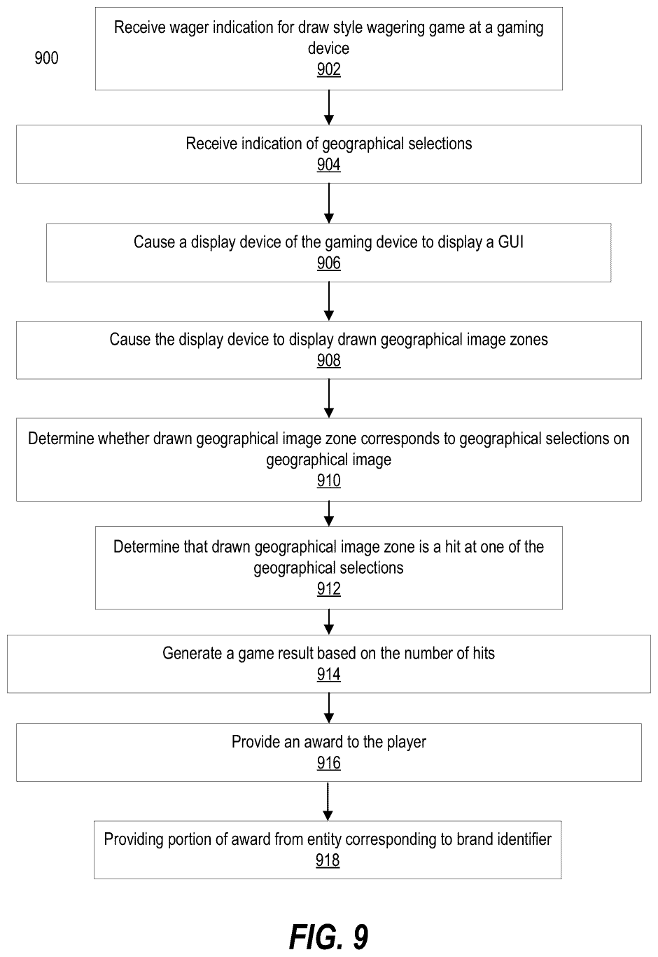

Reference is now made to FIG. 9, which is a flowchart illustrating operations 900 of systems/methods for performing embodiments described herein. The operations 900 may include receiving (block 902) an indication of a wager for a draw-style wagering game by a player using a gaming device and receiving (block 904) an indication of multiple geographical selections on a geographical image for the draw-style wagering game using the gaming device. Operations include causing (block 906) a display device of the gaming device to display a graphical user interface (GUI). The GUI may include the geographical image including multiple geographical image zones and, the geographical selections on the geographical image. Operations may further include causing (block 908) the display device to display multiple drawn geographical image zones corresponding to the geographical image. For each drawn geographical image, operations include determining (block 910) whether the drawn geographical image zone corresponds to any of the geographical selections on the geographical image. For each drawn geographical image zone that corresponds to one of the geographical selections, operations include determining (block 912) that the drawn geographical image zone is a hit and displaying a hit indicator at the geographical selections corresponding to the drawn geographical image zone. Based on a number of hits, operations include generating (block 914) a game result for the draw-style wagering game. In response to the game result being a winning game result, operations include providing (block 916) an award to a player of the draw-style wagering game.

In some embodiments, the geographical image includes a map image corresponding to a real and/or fictitious geographical location. For example, the geographical image may correspond to a globe or global map, a country and/or region thereof, a state and/or region thereof, and/or a city and/or portion thereon. In some embodiments, the geographical image may correspond to a fictitious map corresponding to a fictional world in a fictional movie, show and/or book, among others. Some embodiments provide that the geographical location is configured to receive one of the geographical selections from the player as a location on the map image.

In some embodiments, ones of the geographical selections include multiple user selectable shapes and/or shape sizes. Some embodiments provide that a wager amount is determined based on a selected shape and/or shape size. In some embodiments, the wager amount corresponding to a selected first shape and/or size is greater than the wager amount corresponding to a selected second shape and/or size that is larger than the first selected shape and/or size.

In some embodiments, ones of the geographical selections are associated with a commercial brand including a specific location on the geographical image.

Some embodiments provide that generating the game result includes determining an overlapping portion between the drawn geographical image and corresponding ones of the geographic selections.

In some embodiments, generating the game result includes determining the geographic selection that is most proximal to one of the drawn geographical image zones. In some embodiments, the geographical selections may be defined as a center point and a radius. Embodiments further provide that the radius includes a first radius that corresponds to a first portion of the geographical image and a second radius that corresponds to a second portion of the geographical image that is different from the first portion of the geographical image. In such embodiments, the second radius is different from the first radius based on a difference between the first and second portions of the geographical image.

Some embodiments provide that ones of the geographical selections include an irregular shape that is input by the player. In some embodiments, a wager amount corresponding to the irregular shape is calculated based on an area feature therein and a size of the irregular shape on the geographical image.

In some embodiments, the player is a first player corresponding to a first one of the geographical selections and a second player corresponding to a second one of the geographical selections. Some embodiments provide that the award includes a first award amount and a second award amount that is different from the first award amount. In some embodiments, the first award amount corresponds to the first one of the geographical selections being a first distance from one of the drawn geographical image zones. Some embodiments provide that the second award amount corresponds to the second one of the geographical selections being a second distance from one of the drawn geographical image zones and that the first distance is different from the second distance.

Some embodiments provide that, responsive to the second distance being greater than the first distance, the first award amount is greater than the second award amount.

In some embodiments, the geographical image including the geographical image zones includes a brand identifier symbol. Some embodiments provide that, responsive to one of the geographical selections being proximate the brand identifier symbol, providing a portion of the award from an entity corresponding to the brand identifier symbol.

In some embodiments, the geographical image including the geographical image zones includes a charity symbol. Some embodiments provide that, responsive to one of the geographical selections being proximate the charity symbol, providing a portion of the award to a charity that is associated with the charity symbol.

In some embodiments, one of the geographical selections includes a location pin that includes an interest symbol that corresponds to an organization that is unrelated to the draw-style wagering game. In response to receiving the award corresponding to that interest symbol, a portion of the award is awarded to the organization.

In some embodiments, receiving the indication of the geographical selections includes receiving a location value of a point on the geographical image and modifying an initial shape around the point to be a different shape and/or shape size.

In some embodiments, a first one of the geographic image zones corresponds to a first award amount and a second one of the geographic image zones corresponds to a second award amount that is different from the first award amount based on the first and second ones of the geographic image zones being at different locations on the geographic image.

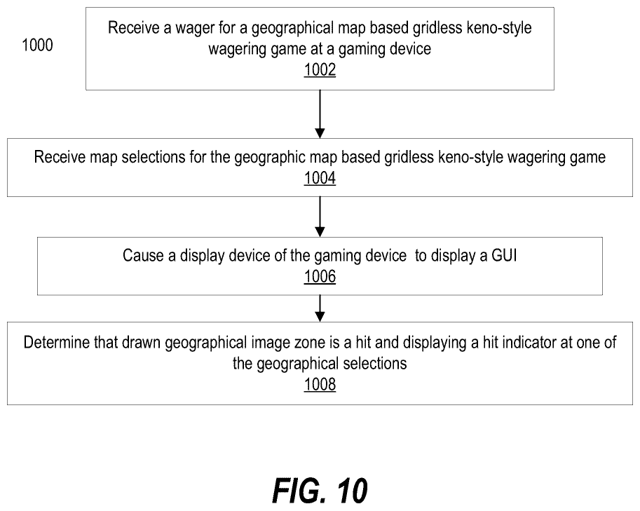

Reference is now made to FIG. 10, which is a flowchart illustrating operations 1000 of systems/methods for performing embodiments described herein. The operations 1000 may include receiving (block 1000) a wager for a geographic map based gridless keno-style wagering game at a gaming device and receiving (block 1004) multiple map selections for the geographic map based gridless keno-style wagering game at the gaming device. Operations further include causing (block 1006) a display device of the gaming device to display a graphical user interface (GUI). Some embodiments provide that the GUI includes a geographic map including multiple map features, multiple geographical selections on the geographic map, and multiple drawn geographical image zones corresponding to portions of the geographic map that are determined from a draw. For each drawn geographical image zone that corresponds to of the plurality of geographical selections, operations include determining (block 1008) that the drawn geographical image zone is a hit and displaying a hit indicator at the one of the plurality of geographical selections corresponding to the drawn geographical image zone.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
receive an indication of a wager for a draw-style wagering game by a player using a gaming device;
receive an indication of a plurality of geographical selections on a geographical image for the draw-style wagering game using the gaming device;
cause a display device of the gaming device to display a graphical user interface (GUI) comprising:
the geographical image comprising a plurality of geographical image zones;
the plurality of geographical selections on the geographical image;
cause the display device to display a plurality of drawn geographical image zones corresponding to the geographical image;
for each drawn geographical image zone, determine whether the drawn geographical image zone corresponds to any of the plurality of geographical selections on the geographical image;
for each drawn geographical image zone that corresponds to one of the plurality of geographical selections, determine that the drawn geographical image zone is a hit and display a hit indicator at the one of the plurality of geographical selections corresponding to the drawn geographical image zone;
based on a number of hits, generate a game result for the draw-style wagering game; and
in response to the game result being a winning game result, provide an award to a player of the draw-style wagering game.

2. The system of claim 1, wherein the geographical image comprises a map image corresponding to a real and/or fictitious geographical location that is configured to receive one of the plurality of geographical selections from the player as a location on the map image.

3. The system of claim 2, wherein ones of the plurality of geographical selections comprise a plurality of user selectable shapes and/or shape sizes, and wherein a wager amount is determined based on a selected shape and/or shape size.

4. The system of claim 3, wherein the wager amount corresponding to a selected first shape size is greater than the wager amount corresponding to a selected second size that is larger than the first selected shape size.

5. The system of claim 1, wherein ones of the plurality of geographical selections are associated with a commercial brand comprising a specific location on the geographical image.

6. The system of claim 1, wherein generating the game result comprises determining an overlapping portion between the drawn geographical image and corresponding ones of the plurality of geographic selections.

7. The system of claim 1, wherein generating the game result comprises determining the one of the plurality of geographic selections that is most proximal to one of the drawn geographical image zones.

8. The system of claim 1, wherein ones of the plurality of geographical selections are defined as a center point and a radius.

9. The system of claim 8, the radius comprises a first radius that corresponds to a first portion of the geographical image and a second radius that corresponds to a second portion of the geographical image that is different from the first portion of the geographical image, and wherein the second radius is different from the first radius based on a difference between the first and second portions of the geographical image.

10. The system of claim 1, wherein ones of the plurality of geographical selections comprise an irregular shape that is input by the player.

11. The system of claim 10, wherein a wager amount corresponding to the irregular shape is calculated based on an area feature therein and a size of the irregular shape on the geographical image.

12. The system of claim 1, wherein the player comprises a first player corresponding to a first one of the plurality of geographical selections and a second player corresponding to a second one of the plurality of geographical selections,
wherein the award comprises a first award amount and a second award amount that is different from the first award amount,
wherein the first award amount corresponds to the first one of the plurality of geographical selections being a first distance from one of the plurality of drawn geographical image zones,
wherein the second award amount corresponds to the second one of the plurality of geographical selections being a second distance from one of the plurality of drawn geographical image zones,
wherein the first distance is different from the second distance.

13. The system of claim 12, wherein, responsive to the second distance being greater than the first distance, the first award amount is greater than the second award amount.

14. The system of claim 1, wherein the geographical image comprising the plurality of geographical image zones comprises a brand identifier symbol,
wherein responsive to one of the plurality of geographical selections being proximate the brand identifier symbol, providing a portion of the award from an entity corresponding to the brand identifier symbol.

15. The system of claim 1, wherein the geographical image comprising the plurality of geographical image zones comprises a charity symbol, wherein responsive to one of the plurality of geographical selections being proximate the charity symbol, providing a portion of the award to a charity that is associated with the charity symbol.

16. The system of claim 1, wherein one of the plurality of geographical selections comprises a location pin that comprises an interest symbol that corresponds to an organization that is unrelated to the draw-style wagering game, and wherein, responsive to receiving the award corresponding to that interest symbol, awarding a portion of the award to the organization.

17. The system of claim 1, receiving the indication of a plurality of geographical selections comprises receiving a location value of a point on the geographical image and modifying an initial shape around the point to be a different shape and/or shape size.

18. The system of claim 1, wherein a first one of the plurality of geographic image zones corresponds to a first award amount and a second one of the plurality of geographic image zones corresponds to a second award amount that is different from the first award amount based on the first and second ones of the geographic image zones being at different locations on the geographic image.

19. A gaming device comprising:
a display device;
an input device;
a processor circuit; and
a memory comprising machine-readable instructions that, when executed by the processor circuit, cause the processor circuit to:
receive, via the input device, an indication of a wager for a draw-style wagering game by a player using a gaming device;
receive, via the input device, an indication of a plurality of geographical selections on a geographical image for the draw-style wagering game using the gaming device;
cause the display device of the gaming device to display a graphical user interface (GUI) comprising:
the geographical image comprising a plurality of geographical image zones;
the plurality of geographical selections on the geographical image;
cause the display device to display a plurality of drawn geographical image zones corresponding to the geographical image;
for each drawn geographical image, determine whether the drawn geographical image zone corresponds to any of the plurality of geographical selections on a geographical image;
for each drawn geographical image zone that corresponds to one of the plurality of geographical selections, determine that the drawn geographical image zone is a hit and display a hit indicator at the one of the plurality of geographical selections corresponding to the drawn geographical image zone;
generate a game result for the draw-style wagering game; and
in response to the game result being a winning game result, provide an award to a player of the draw-style wagering game.

20. A method comprising:
receiving a wager for a geographic map based gridless keno-style wagering game at a gaming device;
receiving a plurality of map selections for the geographic map based gridless keno-style wagering game at the gaming device;
causing a display device of the gaming device to display a graphical user interface (GUI) comprising:
a geographic map comprising a plurality of map features;
a plurality of geographical selections on the geographic map;
plurality of drawn geographical image zones corresponding to portions of the geographic map that are determined from a draw; and
for each drawn geographical image zone that corresponds to of the plurality of geographical selections, determine that the drawn geographical image zone is a hit and display a hit indicator at the one of the plurality of geographical selections corresponding to the drawn geographical image zone.
